(19) United States
(12) Patent Application Publication
(10) Pub. No.: US 2010/0151434 A1
(43) Pub. Date: Jun. 17, 2010

(54) METHOD OF AND APPARATUS FOR TEACHING SIMPLE MECHANICS

(76) Inventor: Frank H. Dyksterhuis, Queensland (AU)

Correspondence Address: ABELMAN, FRAYNE & SCHWAB, 666 THIRD AVENUE, 10TH FLOOR, NEW YORK, NY, 10017, US

(21) Appl. No.: 12/733,154

(22) PCT Filed: Aug. 7, 2008
(86) PCT No.: PCT/AU2008/001169

§ 371 Date: Feb. 5, 2010

(30) Foreign Application Priority Data
Aug. 7, 2007 (AU) 2007904245

(51) Int. Cl. G09B 25/00

(52) U.S. Cl. 434/365

(57) ABSTRACT

Apparatus for teaching mechanics including: support means having a plurality of mounting locations in spaced relationship from each other mounting location, a plurality of mechanical elements each mountable to any one of said mounting locations of said support means for rotation about a rotation axis, wherein: the spacing of the mounting locations is such that a pair of mechanical elements mounted one to each of any adjacent pair of mounting locations are in mechanical association with one another for contra-rotation with respect to one another; and further such that when the number of mechanical elements mounted to successive adjacent mounting locations in a closed loop of mechanical elements is not divisible by two, rotation of the mechanical elements is not possible by virtue of the respective mechanical association with one another.

### FIELD OF INVENTION

THIS INVENTION relates to a method of and apparatus for teaching simple mechanics. The present invention is primarily directed to teaching anew or reinforcing the teaching of intermeshing gears. However, the invention is not limited thereto nor to such field of use. For example, the use of the present invention may involve the teaching and learning and development of strategic planning skills.

### BACKGROUND ART

Teaching mechanics can be straightforward, and once grasped, the principles thereof are not readily forgotten. That being so, the understanding of meshing cogs may be more deeply ingrained if individuals are required to solve problems using intermeshing gears. With the introduction of a competitive element, individuals may be taught to develop strategic planning skills in game play which can be of assistance in the solution of complex mechanical problems such as may be encountered in the development of complex automatic machinery.

The present invention aims to provide a method of and apparatus for teaching simple mechanics which addresses one or more of the aforementioned issues. Other aims and advantages of the invention may become apparent from the following description.

### DISCLOSURE OF THE INVENTION

With the foregoing in view, the present invention in apparatus for teaching mechanics including:

support means having a plurality of mounting locations in spaced relationship from each other mounting location,

a plurality of mechanical elements each mountable to any one of said mounting locations of said support means for rotation about a rotation axis, wherein:

the spacing of the mounting locations is such that a pair of mechanical elements mounted one to each of any adjacent pair of mounting locations are in mechanical association with one another for contra-rotation with respect to one another; and further such that when the number of mechanical elements mounted to successive adjacent mounting locations in a closed loop of mechanical elements is not divisible by two, rotation of the mechanical elements is not possible by virtue of the respective mechanical association with one another.

In such form, each mechanical element includes association means for mechanical association with one or more other mechanical elements when mounted to adjacent mounting locations whereby rotation of any mechanical element may cause contra-rotation of any mechanically associated mechanical element. Preferably, each mechanical element is a cog of substantially equal diameter to the other cogs. In typical form, the cogs each have a plurality of teeth disposed about their periphery whereby mechanical association of each cog is constituted by enmeshing of the teeth of one cog with the teeth of an adjacent cog.

Preferably, the cogs each include a axially extending apertures into or through the cog. In such form, the mounting locations include a spike or the like in complementary form to the aperture or apertures in or through each cog. In a preferred form, the cogs are provided in a plurality of sets of cogs marked or formed to be distinguishable from one another. Preferably, two or three sets of cogs, each of a different colour, are provided. The spikes preferably are arranged in a spaced triangular pattern about the support means, substantially parallel to one another and protruding a distance sufficient to permit a cog mounted thereto by way of inserting the spike into or through the complementary aperture for rotation about the axis of the spike and aperture. The spacing is selected such that cogs mounted on or to adjacent spikes enmesh with one another.

In such form, it will be seen that if cogs are mounted in line with one another across the support means, adjacent cogs may be turned in contra-rotating fashion. However, the placement of a cog to enmesh with two adjacent cogs would prevent the cogs from turning. Accordingly, a paradigm for teaching simple mechanics may be adopted by proposing a competition between contestants in a game or contest. The competition preferably involves two contestants or teams of contestants, one for each colour of the cogs, being set a goal of meshing cogs which can turn and can be prevented from turning as part of a game or contest.

Although the apparatus has been described in physical form, it will be appreciated that the apparatus may also be provided in graphic and/or animated form such as may be provided on a computer, the teaching apparatus and method of the present invention being embodied in a computer contest or the like.

In another aspect, the present invention resides broadly in a method of teaching mechanics including:

providing apparatus for teaching mechanics as hereinbefore described;

mounting successive mechanical elements to said mounting locations to provide mechanical association with respect to one another and/or to provide a counter effect to such mechanical association.

Preferably, the mounting of successive mechanical elements is performed according to a paradigm involving two or more competitors in a competition in which a goal is set in respect of the mounting of the mechanical elements to the mounting locations. Preferably, the paradigm provides for the mounting of successive mechanical elements in mechanical association with one another as well as for the counter effect hereinbefore described.

### BRIEF DESCRIPTION OF THE DRAWINGS

In order that the invention may be more readily understood and put into practical effect, one preferred embodiment of the present invention will by way of example be described with reference to the following drawings, and wherein:

FIG. 1 is a diagrammatic representation of teaching apparatus according to the invention including a control cog and a cog for each of two contestants;

FIG. 2 is a diagrammatic representation of the teaching apparatus of FIG. 1 with an extra contestant's cog;

FIG. 3 is a diagrammatic representation of the teaching apparatus of FIGS. 1 and 2 with another extra contestant's cog;

FIGS. 4 and 5 are diagrammatic representations of the teaching apparatus of FIGS. 1 to 3, but at respective further stages of solution;

FIGS. 6 and 7 are each diagrammatic representation of the teaching apparatus of FIGS. 1 to 4 illustrating examples contest strategy.

### DETAILED DESCRIPTION OF THE DRAWINGS

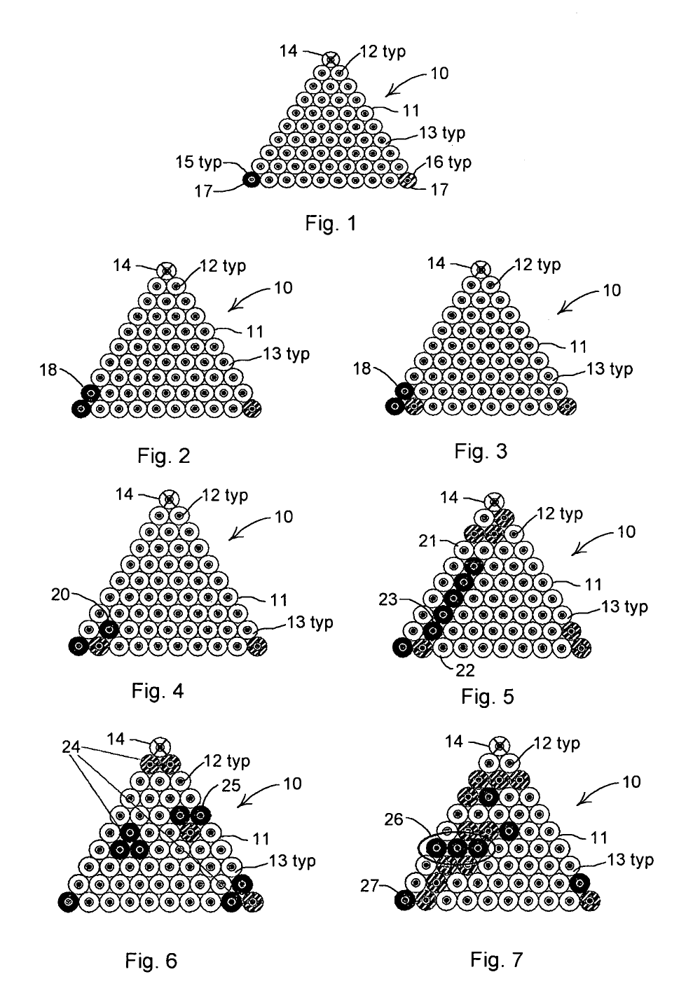

The teaching apparatus 10 shown in FIGS. 1 to 7 includes a triangular support 11 having 55 mounting spikes shown typically at 12 having an equilateral triangular spaced apart arrangement and each central within a respective cog housing shown typically at 13. A master cog 14 is provided on one of the spikes, specifically the spike at the apex of the triangular support and marked with X. The master cog is free to rotate in its housing (subject to constraints described hereinunder). Each contestant is provided with a set of cogs, each set being of a different colour or marking. In the drawings, one set of cogs is shown as dark cogs typically at 15 and the other set of cogs is shown as striped cogs typically at 16. FIG. 1 shows the lay out of the teaching apparatus in general and the triangular support in particular and includes a dark cog for one of the contestants in the bottom left hand corner and a striped cog for the other contestant in the bottom right hand corner and this would be the typical starting position for a contest or competition between the contestants and described hereunder with reference to FIGS. 2 to 7.

The object of the contest is to turn the top cog wheel or master cog by creating a linked path of cogs from a base wheel 17 to the master cog. The first contestant to successfully create such a path so that a turn of the base wheel rotates the master cog wins the contest. However, during contest play, the contestant must be able to turn their base wheel at the end of their turn; otherwise they must make a different move. If a contestant's opponent is able to block the rotation of the base wheel, such that that contestant is still unable to unblock that move, then that contestant (who cannot move their base wheel at the end of their turn) defaults and the other contestant (the opponent) wins the contest.

In an example of a contest, each contestant may be provided with 15 cog wheels of their colour as well as the contest book explaining the rules, the board and the master cog. Before commencing the contest, the master cog is placed at the apex of the contest board. Each contestant now places his or her base wheel at the designated peg on the remaining opposed corners of the triangle. The base wheel must be in position at all times during the contest and cannot be removed from the support by either contestant.

The object of the contest is to turn the master cog by creating a linked path from the base wheel to the master cog. Alternatively, a contestant may block the opponent's cog wheels such that even after their move they are unable to turn their base wheel. Start of play can be determined at random, such as by tossing a coin. The contestants take turns to place one of their cog wheels at a time on any available peg anywhere on the board trying to create a path from their base wheel to the top wheel or trying to block their opponent's base wheel from turning. During their move, contestants have the option of either introducing their fresh cog on the board or moving a cog already on the board to a different location. Each contestant is allowed only one action per move.

In the example shown in FIG. 2, the first contestant places their dark cog at location 18. In response thereto, the other contestant may place their striped cog wheel at location 19 as shown in FIG. 3. It can be seen that this move prevents the contestant with the dark cogs from turning their base wheel. This means that the cog at location 18 cannot be left there and instead of placing a new dark cog on any of the remaining pegs, the contestant is required to remove their cog from location 18. In the example, the cog has been placed it at location 20 as shown in FIG. 4.

In any move, contestants may introduce a fresh cog wheel into the board or alternatively may choose to move one of their cog wheels already on the board to another spot on the board. This is imperative when a contestant has blocked in such a way that their base wheel no longer turns. Contestants are not allowed to move their opponent's pieces to a different location at any time in the contest. However contestants are allowed to include their opponent's cog wheels in their train of cogs to keep their home wheel able to turn. It is suggested that it is quite likely during the course of the contest that turning a base wheel of one colour will turn several linked cog wheels including some of the opponent's cog wheels and perhaps even their base wheel. This is permitted even while turning the top wheel or master cog.

Progress of the contest may produce a board like the example shown in FIG. 5. On the supposition that it is now the turn of the contestant with the striped cogs to have their turn, the threat to the contestant with the striped cogs is that the contestant with the dark cogs will now place a cog on the peg at location 21 and then be able to rotate the whole string of cogs straight up to the master cog and therefore win the contest. The striped cog contestant could counter this move by placing a striped cog at location 22 and thus forcing the dark cog contestant to move a dark cog, probably the one at location 23 it can be seen that any triangular formation will not be able to be turned and forms an effective block.

It can be seen in FIG. 6 that no contestant is allowed to create a triangular formation in his or her own colour. Contestants are not allowed to block any of the corner cogs with their own cogs. Thus the non-permitted arrangements are shown with reference numeral 24, but the triangular formation shown at 25 is permitted because one of the contestants has created it using two adjacent cogs.

The master cog may at times be difficult to reach. Contestants also have the option to block their opponent in such a way that they can no longer free their base wheel. This is shown in FIG. 7 where with the arrangement shown within the ellipse 26, the removal of any single dark cog from the three at that location will not unblock the dark base wheel 27, leading to the striped cog contestant becoming the winner of the contest.

In use, the contest challenges each contestant to think a few steps ahead. Contestants should be alert for placements of any new cogs by their opponent which could create a block and therefore force taking certain action. Also contestants should watch out for moving of any of the opponent's cogs from a block which may suddenly open up the block and create a path to the master cog. Contestants should watch out for the permissible locations for any of their cogs. The existence of non-permitted formations results in the exclusion of several positions on the board. It is also suggested to try to create a double block to eliminate the opponent. In doing so, play will ensure a win. Similarly, contestants should be careful about multiple blocks on the board. Sometimes several of these blocks could be connected to the base wheel by just a single move and cause loss of the contest.

Although the invention has been described with reference to one specific example, it will be appreciated by those skilled in the art that the invention may be embodied in other forms within the broad scope and ambit of the invention as herein set forth and provisionally defined by the following claims.

1. Apparatus for teaching mechanics including:
support means having a plurality of mounting locations in spaced relationship from each other mounting location,
a plurality of mechanical elements each mountable to any one of said mounting locations of said support means for rotation about a rotation axis, wherein:
the spacing of the mounting locations is such that a pair of mechanical elements mounted one to each of any adjacent pair of mounting locations are in mechanical association with one another for contra-rotation with respect to one another; and
further such that when the number of mechanical elements mounted to successive adjacent mounting locations in a closed loop of mechanical elements is not divisible by two, rotation of the mechanical elements is not possible by virtue of the respective mechanical association with one another.

2. Apparatus for teaching mechanics according to claim 1, wherein each mechanical element includes association means for mechanical association with one or more other mechanical elements when mounted to adjacent mounting locations whereby rotation of any mechanical element may cause contra-rotation of any mechanically associated mechanical element.

3. Apparatus for teaching mechanics according to claim 2, wherein each mechanical element is a cog of substantially equal diameter to the other cogs, the cogs each have a plurality of teeth disposed about their periphery whereby mechanical association of each cog is constituted by enmeshing of the teeth of one cog with the teeth of an adjacent cog, the cogs each include an axially extending apertures into or through the cog and the mounting locations include a spike or the like in complementary form to the aperture or apertures in or through each cog.

4. Apparatus for teaching mechanics according to claim 3, wherein the mechanical elements are cogs of substantially equal diameter whereby mechanical association of each cog is enmeshing of their respective teeth.

5. Apparatus for teaching mechanics according to claim 4, wherein the cogs are provided in a plurality of sets of cogs marked or formed to be distinguishable from one another.

6. Apparatus for teaching mechanics according to claim 4, wherein the cogs are comprised in a plurality of sets of cogs marked or formed to be distinguishable from one another.

7. Apparatus for teaching mechanics according to claim 5, wherein the spikes are arranged in triangular disposition about the support means, substantially parallel to one another and protruding a distance sufficient to permit a cog mounted thereto by way of inserting the spike into or through the complementary aperture.

8. Apparatus for teaching mechanics according to claim 1 and including a paradigm for teaching simple mechanics proposing a competition between contestants in a contest.

9. Apparatus for teaching mechanics according to claim 1 in graphic and/or animated form.

10. Apparatus for teaching mechanics according claim 9, wherein the graphic and/or animated form is embodied in a computer program.

11. A method of teaching mechanics including:
providing apparatus for teaching mechanics as hereinbefore described;
mounting successive mechanical elements to said mounting locations to provide mechanical association with respect to one another and/or to provide a counter effect to such mechanical association.

12. (canceled)
